(19) United States
(12) Patent Application Publication
(10) Pub. No.: US 2024/0401540 A1
(43) Pub. Date: Dec. 5, 2024

(54) Method for Checking a Tank System of a Vehicle Having an Internal Combustion Engine, More Particularly of a Motorcycle, and a Motorcycle

(71) Applicant: Bayerische Motoren Werke Aktiengesellschaft, Muenchen (DE)

(72) Inventors: Rolf KIESEWETTER-MICHLER, Eching (DE); Michael PROBST, Freising (DE)

(21) Appl. No.: 18/691,512

(22) PCT Filed: Sep. 23, 2022
(86) PCT No.: PCT/EP2022/076484

§ 371 Date: Mar. 13, 2024

(30) Foreign Application Priority Data
Oct. 14, 2021 (DE) 10 2021 126 600.9

(51) Int. Cl. F02D 41/00; B62J 35/00; F02M 25/08

(52) U.S. Cl. CPC F02D 41/003; B62J 35/00; F02M 25/0836

(57) ABSTRACT

In a method for checking a tank system of a vehicle having an internal combustion engine, more particularly of a motorcycle, a tank vent valve is opened for a predefined angle range of an angle of rotation of a crankshaft of the internal combustion engine during an intake stroke of a cylinder of the internal combustion engine, over a plurality of intake strokes, and fluid is drawn from the fuel tank into a suction line via a filter. A pressure upstream of the tank vent valve is measured, and the measured pressure values are analyzed. The internal combustion engine is a single-cylinder engine or a two-cylinder boxer engine.

### BACKGROUND AND SUMMARY

The invention relates to a method for checking a tank system of a vehicle with an internal combustion engine, in particular of a motorcycle, and to a motorcycle equipped with the tank system.

Research by the Californian environmental agency CARB has shown that a considerable proportion of the emissions caused by motorcycles during travel can be attributed to organic compounds in leaking or faulty tank systems.

The fuel tank of a vehicle operated using an internal combustion engine is connected to the environment in order to be able to compensate for pressure differences, which arise, for example, during refueling, during fuel consumption or on account of temperature fluctuations. In this case, an exchange of air must be possible in both directions. For this purpose, in one widespread application, provision is made for a tank ventilation valve, which is connected to an air supply line of the internal combustion engine, and for a fresh air supply to the tank. In order to prevent fuel from passing unburnt into the environment, an activated carbon filter, which absorbs and temporarily stores the gaseous fuel contained in the air flowing out, is usually arranged in the fresh air line. Accordingly, this activated carbon filter has to be regenerated on a regular basis. For this purpose, the tank ventilation valve is opened in a controlled manner and the fuel is supplied from the activated carbon filter to the air supply line and thus to the internal combustion engine.

In the passenger car sector, tank checking systems that monitor the proper functioning of the tank ventilation valve and the leak-tightness of the entire system are already standard. It is planned for the requirements for motorcycles to also be brought into alignment with this standard.

The object of the invention is to make it possible to check a tank system in a simple and cost-effective manner.

This object is achieved using a method for checking a tank system of a vehicle with an internal combustion engine, wherein the tank system comprises a fuel tank, a tank ventilation valve, a filter arranged in the flow path between the fuel tank and the tank ventilation valve, and a suction line, which leads from the tank ventilation valve to an internal combustion engine. The tank ventilation valve is, in each case, opened for a predefined angular range of a rotational angle of a crankshaft of the internal combustion engine during an intake stroke of a cylinder of the internal combustion engine, over a plurality of intake strokes, wherein fluid is drawn from the fuel tank into the suction line via the filter. A pressure upstream of the tank ventilation valve is measured in order to determine pressure values, and the pressure values are evaluated.

During the intake stroke, a negative pressure is produced in the air supply line. Since the air supply line is flow-connected to the suction line, a negative pressure is also formed at the tank ventilation valve. When the tank ventilation valve is opened, fluid is therefore drawn from the fuel tank into the suction line via the filter.

The angle-based activation of the opening of the tank ventilation valve results in a change in pressure that can be expected in a defined manner and can be readily evaluated, even in the case of short opening times of the tank ventilation valve. The impact of the opening times of the tank ventilation valve on the engine operation can therefore be kept very low.

The opening of the tank ventilation valve is carried out, for example, over 5 to 25 intake strokes, in particular approximately 10 intake strokes. It has been found that this allows meaningful pressure values to be obtained with minimal impact on the engine operation.

The tank ventilation valve is opened, for example, over a percentage of 10% to 50%, in particular 15% to 30%, of the intake stroke.

The location of the angular range within the intake stroke can be freely selected, so that different operating points associated with different expected negative pressure values can be used. It is thus possible to tap off a suction line negative pressure that is defined on the basis of an operating point and to set the expected negative pressure in a variable manner within a certain range. The predefined angular range can thus be selected, with respect to the magnitude and the start of the opening of the tank ventilation valve, on the basis of an operating point of the internal combustion engine.

It is preferably possible for the tank system to be shut off from the ambient pressure in a targeted manner in order to be able to control the pressurization in a defined manner. For this purpose, for example, a shut-off valve, through which fresh air reaches the filter, is closed while the tank ventilation valve is open. The shut-off valve can remain closed throughout the entire checking method.

By way of example, the presence of a leak in the tank system can be concluded from the pressure values determined, for example if the maximum negative pressure reached is lower than expected.

A malfunction of the tank ventilation valve can also be concluded from the pressure values determined, for example if the pressure fluctuations over a plurality of intake strokes are more or less pronounced than expected.

A pressure sensor is preferably positioned between the tank and the filter and is used to determine the pressure values. The pressure is then measured upstream of the filter.

The introduction of the drawn-in fluid into the air supply line to the internal combustion engine preferably takes place downstream of a throttle and therefore bypasses the throttle. The position of the throttle therefore does not directly impact the pressure values determined, even if the throttle predefines the operating point and therefore indirectly has a retroactive effect on the activation.

The drawn-in fluid is preferably constantly supplied to a single cylinder of the internal combustion engine or to a twin-cylinder boxer engine. In this way, the pressure values determined are not impacted by the movement of other cylinders of the internal combustion engine in a phase-shifted stroke.

The invention also relates to a motorcycle with a tank system, which is designed to carry out a method as described above. The tank system comprises a fuel tank, a tank ventilation valve, a filter arranged in the flow path between the fuel tank and the tank ventilation valve, a suction line, which leads from the tank ventilation valve to an internal combustion engine of the motorcycle, and a shut-off valve, which can prevent fresh air from being supplied to the filter. The internal combustion engine is a single-cylinder engine or a twin-cylinder boxer engine.

The invention can be easily applied to all internal combustion engines that have just one cylinder or are in the form of a boxer engine.

However, in the case of the supply of drawn-in fluid into a single cylinder of the internal combustion engine, in the intake stroke of which the angular range for the opening of the tank ventilation valve is located, this cylinder being used to generate the negative pressure in the suction line, the method is, in principle, suitable for all internal combustion engines.

Since the tank ventilation valve is opened for a predefined angular range of the rotational angle of the crankshaft and therefore the expected negative pressure is known, it is possible for the pressure values determined to be evaluated very accurately, despite short opening times of the tank ventilation valve.

The invention will be described in more detail below on the basis of an exemplary embodiment with reference to the appended figures.

### BRIEF DESCRIPTION OF THE DRAWINGS

FIG. 1 is a schematic illustration of a tank system of a motorcycle according to an embodiment of the invention for carrying out a method according to an embodiment of the invention; and

FIG. 2 is a schematic illustration of an angle-based activation of a tank ventilation valve of the tank system from FIG. 1.

### DETAILED DESCRIPTION OF THE DRAWINGS

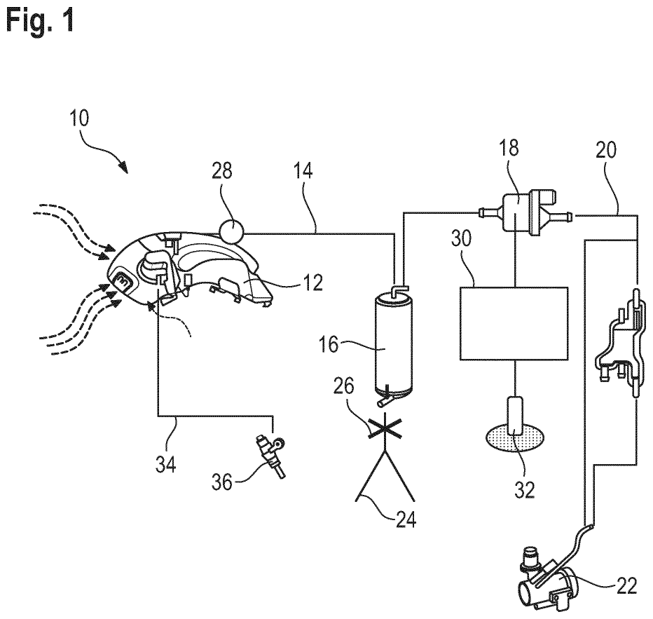

FIG. 1 shows a tank system 10 of an internal combustion engine (not illustrated) of a motorcycle, which is not illustrated in more detail.

The invention is essentially applicable to vehicles with an internal combustion engine and tank system. It is particularly preferably used in a motorcycle. It is therefore explained below on the basis of a motorcycle.

In the context of this application, a motorcycle refers to all single-track vehicles operated using an internal combustion engine, that is to say typical motorcycles and motor scooters as well as, for example, types of vehicle with three wheels.

The tank system 10 comprises a fuel tank 12 (the fuel used is, in this case, gasoline-based and suitable for gasoline engines). The fuel tank 12 is flow-connected via lines 14 to a filter 16, in this case an activated carbon filter, and, downstream of the filter 16, to a tank ventilation valve 18.

A suction line 20 leads from the tank ventilation valve 18 to a throttle 22 in an air supply line, which is not illustrated in more detail, of the internal combustion engine, wherein the suction line 20 opens into the air supply line upstream of the throttle 22.

The suction line 20 is arranged such that the drawn-in fluid flowing therein is constantly supplied to a single, fixed cylinder of the internal combustion engine.

The filter 16 is connected to a fresh air line 24 in which a shut-off valve 26, which can prevent fresh air from being supplied to the filter 16 and air from flowing out from the filter 16 into the environment, is arranged.

Moreover, the tank system 10 comprises a pressure sensor 28, which is arranged in the fuel tank 12 or in the line 14, in this case between the filter 16 and fuel tank 12.

The tank ventilation valve 18 is connected to a control unit 30. The control unit 30 is also connected to all of the other components of the tank system 10, in particular to the pressure sensor 28, and to other vehicle components. This also includes, for example, a lambda sensor 32 in an exhaust gas system (not illustrated) of the internal combustion engine.

The fuel tank 12 is connected to one or more injection valves 36 of the cylinder or cylinders (not illustrated) of the internal combustion engine via a fuel supply line 34.

In this case, the internal combustion engine is a single-cylinder engine or a boxer engine, in particular a twin-cylinder boxer engine.

During normal operation of the internal combustion engine, the pressure in the fuel tank 12 is changed by fuel being removed via the fuel supply line 34 and the injection valve 36, by way of the fuel tank 12 being refilled with fuel and by way of changes in temperature. This can result both in a negative pressure and in an overpressure in relation to the environment. In the normal state, the shut-off valve 26 in the fresh air line 24 is open, so that fresh air can flow into the fuel tank 12 or air can escape from the fuel tank 12. In the case of an overpressure in the fuel tank 12, the gaseous fuel constituents contained are retained in the filter 16, so that only air flows out of the fresh air line 24.

The filter 16 is regenerated on a regular basis. For this purpose, the tank ventilation valve 18 is opened in a manner predefined by the control unit 30, and the filter 16 is purged with fresh air. The resulting fluid, a fuel-air mixture, is supplied to the internal combustion engine via the suction line 20.

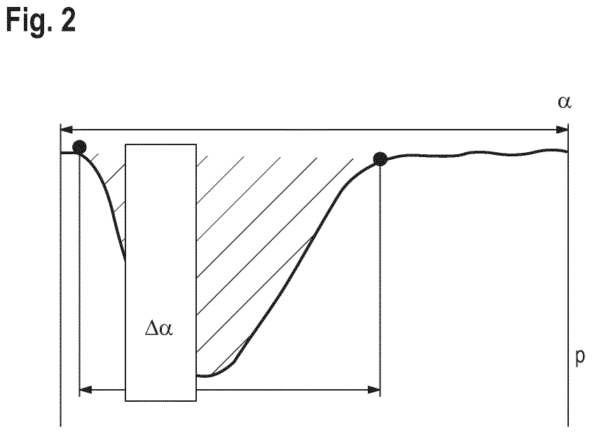

When a diagnostic method for checking the tank system 10, in which the tank system 10 is checked for leaks and/or for proper functioning of the tank ventilation valve 18, is carried out, the tank ventilation valve 18 is briefly opened in accordance with a predefined scheme. This is illustrated in FIG. 2.

The illustrated graph shows a negative pressure p in the suction line 20 plotted against the rotational angle α of a crankshaft driven by the internal combustion engine. The intake stroke of the cylinder connected to the suction line 20 is illustrated. During the intake stroke, a defined, known, angle-dependent negative pressure p is produced. An angular range that can, in principle, be used to carry out the method is shown by the cross-hatching.

This known relationship is used to determine a predefined angular range Δα during which the tank ventilation valve 18 is opened in a controlled manner by the control unit 30. The angular range Δα can be set as desired within the usable angular range, so that different operating points can be utilized to provide the different negative pressure values. The magnitude of the angular range Δα can also be selected as desired, without it exceeding 720°, that is to say the tank ventilation valve 18 is closed at least once every 720°. The start of the predefined angular range Δα, that is to say the starting angle α at which the tank ventilation valve 18 is opened, and the magnitude of the angular range Δα, that is to say the angular difference between the angles at which the tank ventilation valve 18 is opened and closed again, can therefore, at the discretion of a person skilled in the art, be selected freely within the usable angular range.

The tank ventilation valve 18 can be open, for example, over a percentage of approximately 10% to 50%, in particular of approximately 15% to 30%, of the intake stroke, which corresponds to a magnitude of the angular range Δα of around 20° to 90° or around 30° to 55°. The start of the angular range Δα can be set by a person skilled in the art at any suitable angle α in the intake stroke.

The tank ventilation valve 18 is opened over a plurality of intake strokes, for example 5 to 25 intake strokes, in each case preferably over the same angular range Δα.

At the same time as the opening of the tank ventilation valve 18, the shut-off valve 26 in the fresh air line 24 is closed, so that no ambient air can be drawn into the fuel tank 12.

While the tank ventilation valve 18 is open, the pressure gradient is measured using the pressure sensor 28, and pressure values, which are used for the evaluation, are determined.

The evaluation can take place in the control unit 30.

By way of example, the presence of a leak can be concluded if the pressure does not drop as much as expected, or a malfunction of the tank ventilation valve 18 can be concluded if the pressure fluctuation over a plurality of intake strokes is less pronounced than expected. Any other suitable evaluations can of course also be carried out.

Since the clear relationship between the pressure values and the operating point of the cylinder that is responsible for generating the negative pressure is always known, an accurate diagnosis is possible even with small angular ranges Aa, which correspond to short opening times of the tank ventilation valve 18.

1.-10. (canceled)

11. A method for checking a tank system of a vehicle with an internal combustion engine, wherein the tank system comprises a fuel tank, a tank ventilation valve, a filter arranged in a flow path between the fuel tank and the tank ventilation valve, and a suction line, which leads from the tank ventilation valve to the internal combustion engine, the method comprising the steps of:
opening the tank ventilation valve, in each case, for a predefined angular range (Δα) of a rotational angle (α) of a crankshaft of the internal combustion engine during an intake stroke of a cylinder of the internal combustion engine, over a plurality of intake strokes, wherein fluid is drawn from the fuel tank into the suction line via the filter;
measuring a pressure upstream of the tank ventilation valve in order to determine pressure values; and
evaluating the pressure values.

12. The method according to claim 11, wherein the opening of the tank ventilation valve is carried out over 5 to 25 intake strokes.

13. The method according to claim 11, wherein
the tank ventilation valve is opened over a percentage of 10% to 50% of the intake stroke.

14. The method according to claim 11, wherein
the tank ventilation valve is opened over a percentage of 15% to 30% of the intake stroke.

15. The method according to claim 11, wherein
the predefined angular range (Δα) is selected, in terms of magnitude and start of the opening of the tank ventilation valve, based on an operating point of the internal combustion engine.

16. The method according to claim 11, wherein
a shut-off valve, through which fresh air reaches the filter, is closed while the tank ventilation valve is open.

17. The method according to claim 11, wherein presence of a leak in the tank system is concluded from the pressure values.

18. The method according to claim 11, wherein a malfunction of the tank ventilation valve is concluded from the pressure values.

19. The method according to claim 11, wherein
drawn-in fluid is fed, downstream of a throttle, into an air supply line leading to the internal combustion engine.

20. The method according to claim 19, wherein
the drawn-in fluid is constantly supplied to a single cylinder of the internal combustion engine or to a twin-cylinder boxer engine.

21. A motorcycle, comprising:
a single-cylinder or a twin-cylinder boxer internal combustion engine;
a fuel tank;
a tank ventilation valve for the fuel tank;
a filter arranged in a flow path between the fuel tank and the tank ventilation valve;
a suction line, which leads from the tank ventilation valve to the internal combustion engine; and
a shut-off valve, which can prevent fresh air from being supplied to the filter; and
a controller configured to:
open the tank ventilation valve, in each case, for a predefined angular range (Δα) of a rotational angle (α) of a crankshaft of the internal combustion engine during an intake stroke of a cylinder of the internal combustion engine, over a plurality of intake strokes, wherein fluid is drawn from the fuel tank into the suction line via the filter;
measure a pressure upstream of the tank ventilation valve in order to determine pressure values; and
evaluate the pressure values.
